(19) United States
(12) Patent Application Publication
(10) Pub. No.: US 2013/0339493 A1
(43) Pub. Date: Dec. 19, 2013

(54) INFORMATION FEEDBACK METHOD AND CORRESPONDING SERVER

(71) Applicants: Zhi Hao Zheng, Shenzhen City (CN); Yan Jie He, Shenzhen City (CN)

(72) Inventors: Zhi Hao Zheng, Shenzhen City (CN); Yan Jie He, Shenzhen City (CN)

(73) Assignee: Tencent Technology (Shenzhen) Company Limited, Shenzhen City, Guangdong Province (CN)

(21) Appl. No.: 14/002,118

(22) PCT Filed: Jan. 9, 2012
(86) PCT No.: PCT/CN2012/070132

§ 371 Date: Aug. 28, 2013

(30) Foreign Application Priority Data
Feb. 28, 2011 (CN) 201110047745X

(51) Int. Cl. H04L 29/08

(52) U.S. Cl. CPC H04L 67/02
USPC 709/219

(57) ABSTRACT

The present invention discloses an information feedback method and a corresponding server. Through storing the user account identification information of all user accounts of each document transferring chain, the server, when a specified user account in the document transferring chain has an information feedback on a transferred document, the obtains a specified user account identification and a specified document identification of the transferred document in a feedback request, searches the document transferring chain associated with the specified user account transferring the document according to the specified user account identification and the specified document identification, and sends the feedback information to another user account in the searched document transferring chain other than the specified user account having the information feedback. Thus, a chain-way propagation for feedback information is realized.

### FIELD OF THE TECHNIQUE

The present invention relates to an information feedback technique in the internet field, and more particularly to an information feedback method and a server for executing the information feedback method.

### BACKGROUND TECHNIQUE

With the rapid development of Internet technology, blog business gradually rises and becomes a part of people's works and lives. Blog business is a convenient way to release personal information; and through blogs, people can post or publish the personal information in a form of online publication, and classify the posted or published information according to the different user groups or the personal information types. Blogs have gradually become one kind of major medium for people to receive information in their lives.

In blog business, when a user account transfers some information, such as a log, from another user account, the user account may give a comment on the transferred information and a feedback to the information associated with the log.

FIG. 1 is an exemplary transferring chain “A-B-C” in a log transferring network topology diagram; wherein different English letters represent different blog user accounts. “A” published a log in his blog; “B” learned and transferred the log from “A”; and “C” learned the log that is transferred by “B” from “A” and transferred the log from B. Both B and C can have comments on the log, i.e. give information feedback on the log.

However, the current technology at least encounters the following problems:

when “C” performs a feedback on the log transferred by “B” from “A”, “A” cannot receive the feedback information of “C”; when “B” performs a feedback on the log of “A”, “C” cannot also receive the feedback information of “B”. That is, the information feedback of all user accounts in an information transferring chain cannot have chain propagation.

### SUMMARY OF THE INVENTION

The present invention provides an information feedback method and a server for executing the information feedback method. While a user account in an information transferring chain is performing information feedback, the feedback information can be propagated in a chain manner in the information transferring chain. For this object, embodiments of the present invention adopt the following technical solutions:

An embodiment of the present invention provides an information feedback method, which includes: receiving, by a server, a feedback request from a specified user account to obtain a specified user account identification information and a specified document identification information of a specified transferred document in the feedback request, wherein the server stores therein user account identification information of all user accounts in each document transferring chain, and a specified document transferring chain corresponds to the specified transferred document; determining, by the server, the specified document transferring chain according to the specified user account identification information and the specified document identification information; and obtaining, by the server, a user account identification information of another user account in the specified document transferring chain other than the specified user account and sending a feedback information in the feedback request to the another user account according to the obtained user account identification information.

In one embodiment of the present invention, the user account identification information of all user accounts in each the document transferring chain is presented in a document transferring chain table, and in the document transferring chain table, a user account identification information of a publisher of a transferred document and a document identification information of the document in a user account space of the publisher are recorded, and a user account identification information of each user account transferring the document and a document identification information of the produced document in each corresponding user account space are recorded in a document transferring sequence; and the step of determining, by the server, the specified document transferring chain according to the specified user account identification information and the specified document identification information further comprises: searching, by the server, document transferring chain tables stored therein according to the specified user account identification information and the specified document identification information to locate a document transferring chain table including the specified user account identification information and the corresponding specified document identification information, and confirming the specified document transferring chain according to the located document transferring chain table.

In one embodiment of the present invention, if any of the user accounts in the document transferring chain sets a feedback information reception permission, the step of obtaining, by the server, a user account identification information of another user account in the specified document transferring chain other than the specified user account and sending a feedback information in the feedback request to the another user account according to the obtained user account identification information further comprises: after obtaining, by the server, the identification information of the user accounts in the document transferring chain other than the specified user account sending the feedback request, sending the feedback information to specific one or more of the user accounts other than the specified user account according to the feedback information reception permission set by the user account sending the feedback request in the feedback information, wherein the specific one or more user accounts are user accounts permitted by the specified user account sending the feedback request to receive the feedback information sent by the specified user account.

In one embodiment of the present invention, if any of the user accounts in the document transferring chain sets a feedback information display permission, the step of obtaining, by the server, a user account identification information of another user account in the specified document transferring chain other than the specified user account and sending a feedback information in the feedback request to the another user account according to the obtained user account identification information further comprises: after obtaining, by the server, the identification information of the user accounts in the document transferring chain other than the specified user account sending the feedback request, sending the feedback information to specific one or more of the user accounts other than the specified user account according to the feedback information display permission set by the user accounts other than the specified user account, wherein the specific one or more user accounts are user accounts permitted to receive the feedback information sent by the specified user account sending the feedback information.

In one embodiment of the present invention, the server establishes and stores user account identification information of all user account in each document transferring chain by: after receiving a request for transferring a document from a certain user account, the server obtaining a first user account identification of the certain user account issuing the request as well as a first document identification of the transferred document in a user account space of the certain user account carried by the request, and a second user account identification of a source user account as well as a second document identification of the transferred document in a user account space of the source user account; the server checking if there is any document transferring chain table recorded therein the second user account identification information and the corresponding second document identification information as the last item in the document transferring chain table; adding the first user account identification and the corresponding first document identification as an end item in the document transferring chain table in response to a positive check; and establishing a document transferring chain table and sequentially adding the second user account identification as well as the corresponding second document identification and the first user account identification as well as the corresponding first document identification into the document transferring chain table in response to a negative check.

An embodiment of the present invention further provides a server, which includes a storage module, a receiver module, a first obtaining module, a determination module, a second obtaining module and a sender module. The storage module is configured to store user account identification information of all user accounts in each document transferring chain, wherein each the document transferring chain is corresponding to a transferred document. The receiver module is configured to receive a feedback request from a specified user account. The first obtaining module is configured to obtain a specified user account identification information and a specified document identification information of a specified transferred document in the feedback request received by the receiver module. The determination module is configured to determine a corresponding specified document transferring chain according to the specified user account identification information and the specified document identification information obtained by the first obtaining module. The second obtaining module is configured to obtain the an identification information of another user account in the specified document transferring chain other than the specified user account according to information stored in the storage module. The sender module configured to send a feedback information in the feedback request to a corresponding user account according to the user account identification information obtained by the second obtaining module.

In one embodiment of the present invention, the storage module is specifically configured to store user account identification information of all user accounts in each the document transferring chain in form of a document transferring chain table, wherein in the document transferring chain table, a user account identification information of a publisher of a transferred document and a document identification information of the document in a user account space of the publisher are recorded, and a user account identification information of each user account transferring the document and a document identification information of the produced document in each corresponding user account space are recorded in a document transferring sequence. The determination module is specifically configured to search document transferring chain tables stored therein according to the specified user account identification information and the specified document identification information to locate a document transferring chain table including the specified user account identification information and the corresponding specified document identification information, and confirming the specified document transferring chain according to the located document transferring chain table.

In one embodiment of the present invention, if any of the user accounts in the document transferring chain sets a feedback information reception permission, the second obtaining module is further configured to obtain the feedback information reception permission set by a user account sending the feedback request in the feedback information. The sender module is specifically configured to send the feedback information to specific one or more of the user accounts other than the specified user account according to the feedback information display permission obtained by the second obtaining module, wherein the specific one or more user accounts are user accounts permitted to receive the feedback information sent by the specified user account sending the feedback information.

In one embodiment of the present invention, if any of the user accounts in the document transferring chain sets a feedback information display permission, the second obtaining module is further configured to obtain the feedback information display permission set by a user account. The sender module is specifically configured to send the feedback information to specific one or more of the user accounts other than the specified user account according to the feedback information display permission obtained by the second obtaining module, wherein the specific one or more user accounts are user accounts permitted to receive the feedback information sent by the specified user account sending the feedback information.

In one embodiment of the present invention, the storage module further comprises a transferring chain maintenance module configured to, after receiving a request for transferring a document from a certain user account, obtain a first user account identification of the certain user account issuing the request as well as a first document identification of the transferred document in a user account space of the certain user account carried by the request, and a second user account identification of a source user account as well as a second document identification of the transferred document in a user account space of the source user account; check if there is any document transferring chain table recorded therein the second user account identification information and the corresponding second document identification information as the last item in the document transferring chain table; add the first user account identification and the corresponding first document identification as an end item in the document transferring chain table in response to a positive check; and establish a document transferring chain table and sequentially adding the second user account identification as well as the corresponding second document identification and the first user account identification as well as the corresponding first document identification into the document transferring chain table in response to a negative check.

Compared with the prior art, the embodiments of the invention have the following advantages:

through storing the user account identification information of all user accounts of each document transferring chain, the server, when a specified user account in the document transferring chain has an information feedback on a transferred document, the obtains a specified user account identification and a specified document identification of the transferred document in a feedback request, searches the document transferring chain associated with the specified user account transferring the document according to the specified user account identification and the specified document identification, and sends the feedback information to another user account in the searched document transferring chain other than the specified user account having the information feedback. Thus, a chain-way propagation for feedback information is realized.

The aforementioned description is only a concept of the technical solution of the present invention. In order to describe the embodiments of the present invention more clearly, implement the present invention according to the description therein and make the aforementioned and other objects, characteristics and advantages more apparent, the accompanying drawings required for describing the embodiments are briefly introduced hereinafter.

### BRIEF DESCRIPTION OF THE DRAWINGS

FIG. 1 is a schematic diagram illustrating a log transferring network topology in a current technique.

FIG. 2 is a flowchart schematically illustrating an information feedback process according to an embodiment of the present invention.

FIG. 3 is a constructional diagram of a server provided according to an embodiment of the present invention.

### PREFERRED EMBODIMENTS OF THE PRESENT INVENTION

To further illustrate the technical solutions and effects adopted for achieving the objects of the embodiments of the present invention, specific implementation means, structures, features and effects of an information feedback method and a corresponding server are described with a combination of accompanying drawings and preferred embodiments in detail as follow.

Hereinafter, by way of the descriptions of the embodiments of the present invention with reference to the accompanying drawings, the above-mentioned and further technical contents, features and effects of the present invention are clearly and fully described. Through the description of the embodiments, the technical solutions and effects adopted for achieving the objects of the embodiments of the present invention can further be concretely understood. The accompanying drawings are used for references and descriptions only rather than used for limiting the present invention.

In response to the problem that the feedback information fails to form chain propagation in the present technology, an embodiment of the present invention provides an information feedback technical solution. In an embodiment of the present invention, a server establishes and stores user information of all user accounts in a document transferring chain. If a user account in the document transferring chain performs an information feedback on a transferred document, the server obtains a user account identification and a document identification of the transferred document in a feedback request, searches the document transferring chain of the document transferred by the user account according to the user account identification and the document identification, and sends the feedback information to the other user accounts in the located document transferring chain except the user account performing the information feedback. Thus, a chain propagation of the feedback information is realized.

In the following, an example associated with transfer of logs in QQ zone by QQ user accounts is taken to describe a process of establishing and storing user account information of all user accounts in each document transferring chain by a server in an embodiment of the present invention.

A specific application scenario of an embodiment of the present invention includes the following conditions: user accounts A, B and C are all QQ user accounts; user account A publishes a log in QQ zone; user account B browses the log in QQ zone of user account A and transfers the log; and user account C browses the log in B's QQ zone, which is transferred by user account B from the QQ zone of user account A, and transfers the log. Thus, a transferring chain “A-B-C” is constituted by user accounts A, B and C concerning the log. During user accounts B and C directly or indirectly transfer the log of user account A, a server establishes and stores the user identification of each user account in the log transferring chain of the log and the log identification of the log transferred among the associated spaces. The data structure may be in a correspondence table form, such as a log transferring chain table as illustrated in Table. 1.

Specifically, when user account B transfers the log published by user account A (the unique identification of the log in the QQ zone of user account A is “ID a”), the server establishes a correspondence table for the log, records in the correspondence table the correspondence between the user account identification (e.g. QQ number) of user account A and the log identification “ID a” of the log in the QQ zone of user account A, i.e. transferring source information, and after the log is transferred, the user account identification of user account B and the log identification “ID b” of the log in the QQ zone of user account B. When user account C transfers the log with log identification ID b of user account B, the server searches the log transferring chain tables stored therein, and if a log transferring chain table as shown in Table 1 is located with the last item indicating the correspondence between user account B and the log identification ID b, i.e. the transferring source of user account C, further add user account C and the identification “IC c” of the transferred log in the QQ zone of user account C.

TABLE 1

| identification of user | identification of user | identification of user |
|---|---|---|
| account A | account B | account C |
| log identification ID a | log identification ID b | log identification ID c |

As shown, Table 1 records therein the user account information of the publisher and the sequentially follow-up transfer with regards to the same log, i.e. the identification of each user account in the log transferring chain. Alternatively, the user account identification shown in Table 1 may be replaced by any other information feasible to uniquely identify the user account.

Based on the above idea, when it is a new user account transfers the log, the server either establishes a new correspondence table or adds the correspondence between the user account identification of the new user account and the document identification into the established correspondence table according to a specific transfer situation. For example, if user account D transfers the same log from user account A, the server establishes a correspondence table with a transferring chain “A-D”; if user account D transfers the same log from user account B, the server establishes a correspondence table with a transferring chain “A-B-D”; if user account D transfers the same log from user account C, the server adds the correspondence between the user account identification of user account D and the identification “ID d” of the transferred log in the QQ zone of the user account D into the correspondence table of the transferring chain “A-B-C”, thereby establishing a correspondence table with a transferring chain “A-B-C-D”.

It is to be noted that the aforementioned correspondence table, which is established and stored with the user account identification of each user account in the log transferring chain and the log identification of the transferred log in the space of each user account, is just a specific implementation form for the server to store the user account information of each user account in a document transferring chain; and the server may store the user account information of each user account in the transferring chain in other forms. For example, if the document identification of a transferred document does not involve any change during the transferring process, the server may store the user account information of all the user accounts in the transferring chain in as an ordered set of the user accounts in the document transferring chain. For example, for the log transferring chain “A-B-C”, the server may store a set of the user accounts in the log transferring chain as {information of user account A, information of user account B, information of user account C} for the transferred log (i.e. for the unique identification of the log).

If a user account in a transferring chain gives an information feedback on a transferred log, the server may send the feedback information to other user accounts in the transferring chain according to the information of each user account in the transferring chain stored therein.

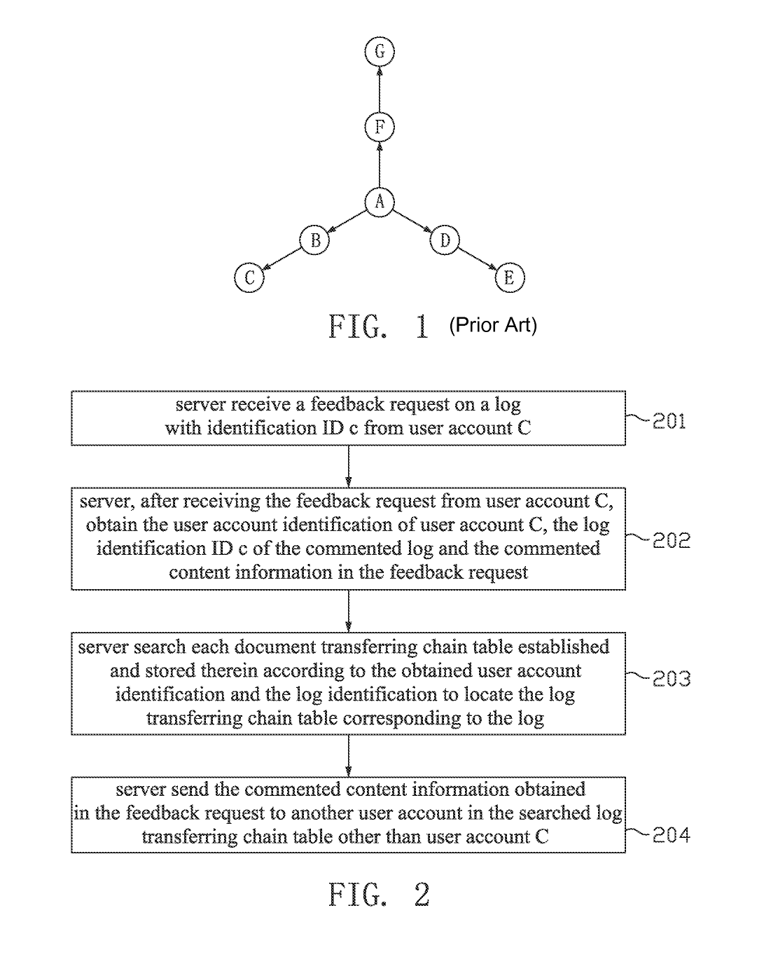

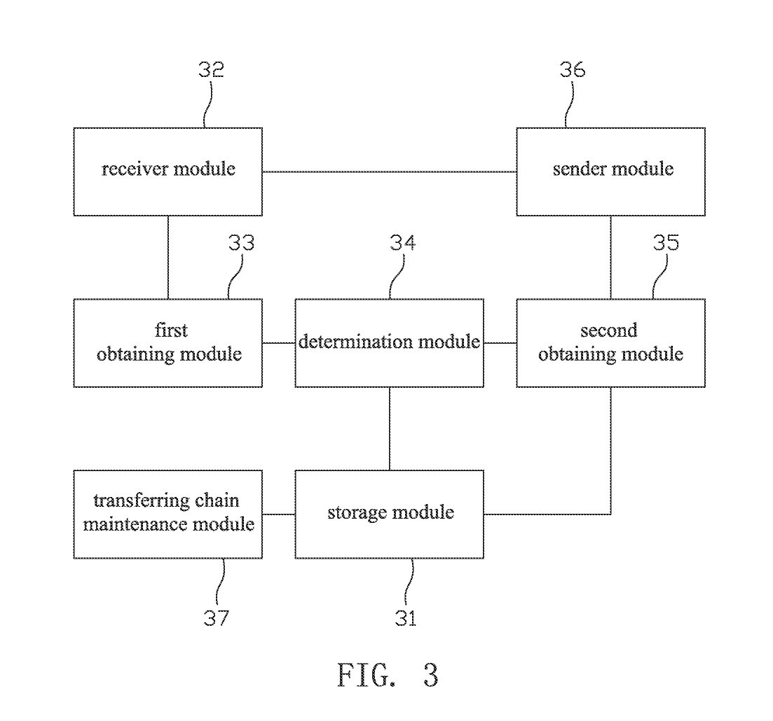

For facilitating descriptions, the following descriptions are based on the above examples with the log transferring chain “A-B-C” resulting from the sequential transfer of the same log by QQ user accounts and the information feedback on the transferred log by a certain user account in the transferring chain. The exemplary scenario is: user account A publishes a log (with identification ID a in the QQ zone of the user account A); user account B transfers the log (with identification ID b in the QQ zone of the user account B) from user account A; user account C transfers the log (with identification ID c in the QQ zone of the user account C) from user account B and gives a comment on the log with identification ID c. Furthermore, the server establishes a log transferring chain table as shown in Table 1 in the process of transferring the log. With regards to the above scenario, the process that the server sends the contents of the comment made by user account C on the log to the direct transferring source and the upper-stage transferring source of the direct transferring source is illustrated in FIG. 2.

FIG. 2 is a flowchart schematically illustrating an information feedback process provided by an embodiment of the present invention. The process may include the following steps:

Step 201, a server receives a feedback request on a log with identification ID c from user account C.

Specifically, user account C gives a comment on the log transferred by him and sends the comment to the server via the feedback request; wherein the request carries the user account identification of user account C, the log identification ID c, and the commented content information (that is, the feedback content information).

Step 202, after receiving the feedback request from user account C, the server obtains the user account identification of user account C, the log identification ID c of the commented log and the commented content information in the feedback request.

Step 203, the server searches each document transferring chain table established and stored therein according to the obtained user account identification and the log identification to locate the log transferring chain table corresponding to the log.

Specifically, after obtaining the user account identification of user account C and the log identification ID c, the server locates Table 1 includes the correspondence between the user account identification of user account C and the log identification ID c as the log transferring chain table corresponding to the transferred log.

Step 204, the server sends the commented content information obtained in the feedback request to another user account in the searched log transferring chain table other than user account C.

Specifically, after finding the log transferring chain table corresponding to the log, the server obtains the user account identification of the another user account (e.g., the user account identifications of user accounts A, B) other than user account C (the user account sending the information feedback) from the table, and sends the comment content given by user account C to the corresponding user accounts (e.g., user accounts A, B) according to the obtained user account identifications.

In the above process, the server herein is referred to as an application server used in QQ business; the user account is referred to as a user account in QQ business; and the user accounts in QQ business exchange information with the server through the client end of the QQ business application.

According to the above description, through storing the user account identification information of all user accounts of each document transferring chain, the server, when a specified user account in the document transferring chain has an information feedback on a transferred document, obtains a specified user account identification and a specified document identification of the transferred document in a feedback request, searches the document transferring chain associated with the specified user account transferring the document according to the specified user account identification and the specified document identification, and sends the feedback information to another user account in the searched document transferring chain other than the specified user account having the information feedback. Thus, a chain-way propagation for feedback information is realized.

In order to restrict the transmission and reception of the information feedback and increase the system flexibility, an embodiment of the present invention may further, based on the aforementioned technical solution foundation, allow the user account to set a feedback information reception permission and/or a feedback information display permission; correspondingly, the process of the chain-way propagation for feedback information may be performed according to the permissions set by the user account.

The feedback information reception permission herein means that only the user account with specific characteristics is permitted to receive the feedback formation from a specified user account setting the feedback information reception permission. The specific characteristics may include user account attributes or a relationship with the specified user account. For a QQ user account, the user accounts with specific characteristics may be a friend user account of the specific user account. Correspondingly, if any specified user account in a log transferring chain has an information feedback on a transferred log and the specified user account sets the feedback information reception permission, the server sends the feedback information to the user accounts permitted by the specified user account according to the feedback information reception permission. For example, in the above scenario, user account B is a good friend of user account C; user account A is not a good friend of user account C; and the reception permission set by user account C indicates that only the good friend thereof can receive the feedback information. Accordingly, after determining the log transferring chain table, the server finds that user account A is not a good friend of user account C and user account B is a good friend of user account C according to the good-friend list of user account C, and then sends the feedback information of user account C to user account B, which belongs to the log transferring chain and is a good friend of user account C.

The feedback information display permission herein means that a specific user account is permitted to receive the feedback information sent from the user accounts with specific characteristics only. The specific characteristics may include user account attributes or a relationship with the specified user account. For a QQ user account, the user accounts with specific characteristics may be a friend user account of the specific user account. Correspondingly, if any specified user account in a log transferring chain has an information feedback on a transferred log and any another user account in the log transferring chain other than the specified user account sets the feedback information display permission, the server sends the feedback information to the user accounts having the permission according to the feedback information display permission. For example, in the above scenario, user account C is a good friend of user account B; user account C is not a good friend of user account A; and the display permission set by user accounts B, A indicates that only the information from a good friend thereof will be displayed. Accordingly, after determining the log transferring chain table, the server finds that user account C is not a good friend of user account A and user account C is a good friend of user account B according to the good-friend list of user accounts A, B, and then sends the feedback information of user account C to user account B, which belongs to the log transferring chain and is a good friend of user account C.

The above two permissions can be used in combination.

It is understood that the information feedback technique provided by the embodiment of the present invention is not only adapted to be used in the information feedback in the log transferring; the technical solution provided by the embodiment of the present invention can be applied to the information feedback in any similar scenario.

Based on the same technical idea, an embodiment of the present invention further provides a server, which can be applied in the aforementioned method process for information feedback.

As illustrated in FIG. 3, which is a constructional diagram of a server provided by an embodiment of the present invention, the server may include:

a storage module 31 configured to store user account identification information of all user accounts in each document transferring chain, wherein each document transferring chain is corresponding to a transferred document;

a receiver module 32 configured to receive a feedback request from a specified user account;

a first obtaining module 33 configured to obtain a user account identification information and a document identification information of a transferred document in the feedback request received by the receiver module 32;

a determination module 34 configured to locate a corresponding document transferring chain according to the user account identification information and the document identification information obtained by the first obtaining module 33;

a second obtaining module 35 configured to obtain a user account identification information of another user account in the document transferring chain other than the specified user account according to the information stored in the storage module 31;

a sender module 36 configured to send the feedback information in the feedback request to corresponding user accounts according to the user account identification information obtained by the second obtaining module 35.

Specifically, the storage module 31 may store user account identification information of all user accounts in each the document transferring chain in form of a document transferring chain table, wherein in the document transferring chain table, a user account identification information of a publisher of a transferred document and a document identification information of the document in a user account space of the publisher are recorded, and a user account identification information of each user account transferring the document and a document identification information of the produced document in each corresponding user account space are recorded in a document transferring sequence.

The determination module 34 may search document transferring chain tables stored in the storage module 31 according to the specified user account identification information and the specified document identification information obtained by the first obtaining module 33 to locate a document transferring chain table including the specified user account identification information and the corresponding specified document identification information, and confirming the specified document transferring chain according to the located document transferring chain table.

In order to restrict the transmission and reception of the information feedback and increase the system flexibility, an embodiment of the present invention may further allow a specified user account to set a feedback information reception permission and/or a feedback information display permission; correspondingly, the process of the chain-way propagation for feedback information may be performed according to the permissions set by the user account.

Specifically, if any of the user accounts in the document transferring chain sets a feedback information reception permission, the second obtaining module 35 is further configured to obtain the feedback information reception permission set by a user account sending the feedback request in the feedback information. The sender module 36 is specifically configured to send the feedback information to specific one or more of the user accounts other than the specified user account according to the feedback information display permission obtained by the second obtaining module 35, wherein the specific one or more user accounts are user accounts permitted to receive the feedback information sent by the specified user account sending the feedback information.

If any of the user accounts in the document transferring chain sets a feedback information display permission, the second obtaining module 35 is further configured to obtain the feedback information display permission set by a user account. The sender module 36 is specifically configured to send the feedback information to specific one or more of the user accounts other than the specified user account according to the feedback information display permission obtained by the second obtaining module 35, wherein the specific one or more user accounts are user accounts permitted to receive the feedback information sent by the specified user account sending the feedback information.

It is to be noted that the server needs to determine, according to a transferring request from the specified user account, to either establish a new document transferring chain table or add a user account identification of a new user account and the corresponding document identification into a stored document transferring chain table when receiving the transferring request from the specified user account.

Specifically, the server provided by an embodiment of the present invention may further include a transferring chain maintenance module 37 configured to, after receiving a request for transferring a document from a certain user account, obtain a first user account identification of the certain user account issuing the request as well as a first document identification of the transferred document in a user account space of the certain user account carried by the request, and a second user account identification of a source user account as well as a second document identification of the transferred document in a user account space of the source user account; check if there is any document transferring chain table recorded therein the second user account identification information and the corresponding second document identification information as the last item in the document transferring chain table; add the first user account identification and the corresponding first document identification as an end item in the document transferring chain table in response to a positive check; and establish a document transferring chain table in the storage module 31 and sequentially adding the second user account identification as well as the corresponding second document identification and the first user account identification as well as the corresponding first document identification into the document transferring chain table in response to a negative check. Wherein, user account A is referred to as the source user account of user account B if user account B transfers a document from the user account space of user account A.

It is to be noted that storing, by the storage module, the user account identification information of all the user accounts in each the respective document transferring chain in form of a document transferring chain table is one exemplary implementation only. The storage module may store the user account identification information of all user accounts in the respective document transferring chain in other forms; and no redundant detail about the specific storing form is to be given herein.

In the embodiment of the present invention, through storing the user account identification information of all user accounts of each document transferring chain, the server, when a specified user account in the document transferring chain has an information feedback on a transferred document, the obtains a specified user account identification and a specified document identification of the transferred document in a feedback request, searches the document transferring chain associated with the specified user account transferring the document according to the specified user account identification and the specified document identification, and sends the feedback information to another user account in the searched document transferring chain other than the specified user account having the information feedback. Thus, a chain-way propagation for feedback information is realized.

It is to be noted that the object to be transferred in the embodiments is not limited to log; the transfer of video or audio files, etc. are also applied to the information feedback method provided in the embodiment of the present invention.

Through the aforementioned descriptions in the embodiments, to those skilled in the art it is understood that the present invention may be realized by software with a necessary hardware platform or by hardware only; however, the former is a preferred implementation way in most cases. Based on such understanding, the essence of the technical solution of the present invention or the contributing part to the prior art can be realized in form of a software product. The computer software product is stored in a storage medium and includes a plurality of instructions for configuring a computer equipment (e.g., a personal computer, server, or network equipment, etc.) to perform the methods in each embodiment of the present invention.

To those skilled in the art, it is understood that the drawings in the present invention are exemplary diagrams for a preferred embodiment only; the modules or processes illustrated in the drawings are not necessary for the implementation of the present invention.

To those skilled in the art, it is understood that the modules in the device embodiment may be arranged in the device in the embodiment according to the embodiment description, or arranged in one or more devices according to various modulations in corresponding embodiments. The modules in the aforementioned embodiment may be corporately integrated into one module; or each may be further divided into a plurality of sub-modules.

What is described above is preferred embodiments according to the present invention only rather than used for limiting the present invention. On the contrary, it is intended to cover various modifications and similar arrangements included within the spirit and scope of the appended claims which are to be accorded with the broadest interpretation so as to encompass all such modifications and similar structures.

### INDUSTRIAL APPLICABILITY

In the present invention, through storing the user account identification information of all user accounts of each document transferring chain, the server, when a specified user account in the document transferring chain has an information feedback on a transferred document, the obtains a specified user account identification and a specified document identification of the transferred document in a feedback request, searches the document transferring chain associated with the specified user account transferring the document according to the specified user account identification and the specified document identification, and sends the feedback information to another user account in the searched document transferring chain other than the specified user account having the information feedback. Thus, a chain-way propagation for feedback information is realized.

What is claimed is:

1. An information feedback method, wherein the method comprises:
receiving, by a server, a feedback request from a specified user account to obtain a specified user account identification information and a specified document identification information of a specified transferred document in the feedback request, wherein the server stores therein user account identification information of all user accounts in each document transferring chain, and a specified document transferring chain corresponds to the specified transferred document;
determining, by the server, the specified document transferring chain according to the specified user account identification information and the specified document identification information; and
obtaining, by the server, a user account identification information of another user account in the specified document transferring chain other than the specified user account and sending a feedback information in the feedback request to the another user account according to the obtained user account identification information.

2. The method according to claim 1, wherein the user account identification information of all user accounts in each the document transferring chain is presented in a document transferring chain table, and in the document transferring chain table, a user account identification information of a publisher of a transferred document and a document identification information of the document in a user account space of the publisher are recorded, and a user account identification information of each user account transferring the document and a document identification information of the produced document in each corresponding user account space are recorded in a document transferring sequence; and
the step of determining, by the server, the specified document transferring chain according to the specified user account identification information and the specified document identification information further comprises:
searching, by the server, document transferring chain tables stored therein according to the specified user account identification information and the specified document identification information to locate a document transferring chain table including the specified user account identification information and the corresponding specified document identification information, and confirming the specified document transferring chain according to the located document transferring chain table.

3. The method according to claim 1, wherein if any of the user accounts in the document transferring chain sets a feedback information reception permission, the step of obtaining, by the server, a user account identification information of another user account in the specified document transferring chain other than the specified user account and sending a feedback information in the feedback request to the another user account according to the obtained user account identification information further comprises:
after obtaining, by the server, the identification information of the user accounts in the document transferring chain other than the specified user account sending the feedback request, sending the feedback information to specific one or more of the user accounts other than the specified user account according to the feedback information reception permission set by the user account sending the feedback request in the feedback information, wherein the specific one or more user accounts are user accounts permitted by the specified user account sending the feedback request to receive the feedback information sent by the specified user account.

4. The method according to claim 1, wherein if any of the user accounts in the document transferring chain sets a feedback information display permission, the step of obtaining, by the server, a user account identification information of another user account in the specified document transferring chain other than the specified user account and sending a feedback information in the feedback request to the another user account according to the obtained user account identification information further comprises:
after obtaining, by the server, the identification information of the user accounts in the document transferring chain other than the specified user account sending the feedback request, sending the feedback information to specific one or more of the user accounts other than the specified user account according to the feedback information display permission set by the user accounts other than the specified user account, wherein the specific one or more user accounts are user accounts permitted to receive the feedback information sent by the specified user account sending the feedback information.

5. The method according to claim 1, wherein the server establishes and stores user account identification information of all user account in each document transferring chain by:
after receiving a request for transferring a document from a certain user account, the server obtaining a first user account identification of the certain user account issuing the request as well as a first document identification of the transferred document in a user account space of the certain user account carried by the request, and a second user account identification of a source user account as well as a second document identification of the transferred document in a user account space of the source user account;
the server checking if there is any document transferring chain table recorded therein the second user account identification information and the corresponding second document identification information as the last item in the document transferring chain table;
adding the first user account identification and the corresponding first document identification as an end item in the document transferring chain table in response to a positive check; and establishing a document transferring chain table and sequentially adding the second user account identification as well as the corresponding second document identification and the first user account identification as well as the corresponding first document identification into the document transferring chain table in response to a negative check.

6. A server, comprising:
a storage module configured to store user account identification information of all user accounts in each document transferring chain, wherein each the document transferring chain is corresponding to a transferred document;
a receiver module configured to receive a feedback request from a specified user account;
a first obtaining module configured to obtain a specified user account identification information and a specified document identification information of a specified transferred document in the feedback request received by the receiver module;
a determination module configured to determine a corresponding specified document transferring chain according to the specified user account identification information and the specified document identification information obtained by the first obtaining module;
a second obtaining module configured to obtain the an identification information of another user account in the specified document transferring chain other than the specified user account according to information stored in the storage module; and
a sender module configured to send a feedback information in the feedback request to a corresponding user account according to the user account identification information obtained by the second obtaining module.

7. The server according to claim 6, wherein:
the storage module is specifically configured to store user account identification information of all user accounts in each the document transferring chain in form of a document transferring chain table, wherein in the document transferring chain table, a user account identification information of a publisher of a transferred document and a document identification information of the document in a user account space of the publisher are recorded, and a user account identification information of each user account transferring the document and a document identification information of the produced document in each corresponding user account space are recorded in a document transferring sequence;
the determination module is specifically configured to search document transferring chain tables stored therein according to the specified user account identification information and the specified document identification information to locate a document transferring chain table including the specified user account identification information and the corresponding specified document identification information, and confirming the specified document transferring chain according to the located document transferring chain table.

8. The server according to claim 6, wherein if any of the user accounts in the document transferring chain sets a feedback information reception permission;
the second obtaining module is further configured to obtain the feedback information reception permission set by a user account sending the feedback request in the feedback information; and
the sender module is specifically configured to send the feedback information to specific one or more of the user accounts other than the specified user account according to the feedback information display permission obtained by the second obtaining module, wherein the specific one or more user accounts are user accounts permitted to receive the feedback information sent by the specified user account sending the feedback information.

9. The server according to claim 6, wherein if any of the user accounts in the document transferring chain sets a feedback information display permission;
the second obtaining module is further configured to obtain the feedback information display permission set by a user account;
the sender module is specifically configured to send the feedback information to specific one or more of the user accounts other than the specified user account according to the feedback information display permission obtained by the second obtaining module, wherein the specific one or more user accounts are user accounts permitted to receive the feedback information sent by the specified user account sending the feedback information.

10. The server according to claim 6, further comprising:
a transferring chain maintenance module configured to, after receiving a request for transferring a document from a certain user account, obtain a first user account identification of the certain user account issuing the request as well as a first document identification of the transferred document in a user account space of the certain user account carried by the request, and a second user account identification of a source user account as well as a second document identification of the transferred document in a user account space of the source user account; check if there is any document transferring chain table recorded therein the second user account identification information and the corresponding second document identification information as the last item in the document transferring chain table; add the first user account identification and the corresponding first document identification as an end item in the document transferring chain table in response to a positive check; and establish a document transferring chain table and sequentially adding the second user account identification as well as the corresponding second document identification and the first user account identification as well as the corresponding first document identification into the document transferring chain table in response to a negative check.
